(19) United States
(12) Patent Application Publication
(10) Pub. No.: US 2026/0253554 A1
(43) Pub. Date: Aug. 27, 2026

(54) DYNAMIC MULTI-ZONE VDD-VSS VOLTAGE CONTROL FOR OLED POWER SAVING

(71) Applicant: Applied Materials, Inc., Santa Clara, CA (US)

(72) Inventors: Yu-Hsin LIN, Zhubei City (TW); Chung-Chia CHEN, Hsinchu City (TW)

(21) Appl. No.: 19/540,824

(22) Filed: Feb. 16, 2026

Related U.S. Application Data
(60) Provisional application No. 63/763,587, filed on Feb. 26, 2025.

(51) Int. Cl. G09G 3/3266; G09G 3/3233; G09G 3/3291

(52) U.S. Cl. CPC G09G 3/3266; G09G 3/3233; G09G 3/3291; G09G 2300/0842; G09G 2320/043

(57) ABSTRACT

Embodiments described herein relate to a display device including a grid divided into zones, each zone with independently adjustable voltage levels that are dynamically adjusted based on the brightness or content requirements of the pixels within that zone, reference voltage (V_{SS}) power lines extending across rows of the grid, and supply voltage (V_{DD}) power lines extending across columns of the grid. Adjusting power delivery includes adjusting reference voltage (V_{SS}) power lines connected to rows of the grid. Adjusting power delivery includes adjusting supply voltage (V_{DD}) power lines connected to columns of the grid. Supply voltage (V_{DD}) and reference voltage (V_{SS}) are configured to be individually controlled in each column or row.

### CROSS-REFERENCE TO RELATED APPLICATIONS

This application claims benefit of United States provisional patent application Ser. No. 63/763,587, filed Feb. 26, 2025, which is herein incorporated by reference in its entirety.

### BACKGROUND

### Field

Embodiments described herein generally relate to a display. More specifically, embodiments described herein relate to sub-pixel circuits and methods of forming sub-pixel circuits that may be utilized in a display such as an organic light-emitting diode (OLED) display.

### Description of the Related Art

Input devices including display devices may be used in a variety of electronic systems. An organic light-emitting diode (OLED) is a light-emitting diode (LED) in which the emissive electroluminescent layer is a film of an organic compound that emits light in response to an electric current. OLED devices are classified as bottom emission devices if light emitted passes through the transparent or semi-transparent bottom electrode and substrate on which the panel was manufactured. Top emission devices are classified based on whether or not the light emitted from the OLED device exits through the lid that is added following the fabrication of the device. OLEDs are used to create display devices in many electronics today. Today's electronics manufacturers are pushing these display devices to shrink in size while providing higher resolution than just a few years ago.

OLED displays operate using a supply voltage (V_{DD}) and a reference voltage (V_{SS}) to power their pixels. Each pixel emits light when current flows through its organic layers, and the brightness is directly proportional to the current. In conventional OLED designs, a fixed V_{DD} and V_{SS} are applied uniformly across the entire panel, regardless of the displayed content. While this simplifies the design, it leads to inefficiencies because not all regions of the display need the same power level at all times. The primary issue with fixed voltages is that they result in wasted power, especially in darker regions or areas displaying static or low-brightness content. OLED power consumption scales non-linearly with pixel brightness, meaning that brighter pixels consume disproportionately more power. Applying the same high V_{DD} across all pixels, even those displaying black or dark colors, results in unnecessary energy usage, heat generation, and faster pixel aging.

### SUMMARY

In one implementation, a display device includes a grid including rows and columns of organic light emitting diode (OLED) diodes, where zones are defined at intersections of the rows and columns, first power lines extending across the rows, and second power lines extending across the columns.

In one implementation, a display device includes a grid divided into zones, each zone with independently adjustable voltage levels that are dynamically adjusted based on the brightness or content requirements of the pixels within that zone, reference voltage (V_{SS}) power lines extending across rows of the grid, and supply voltage (V_{DD}) power lines extending across columns of the grid.

In one implementation, a method includes dividing a display into zones, the display forming a grid of rows and columns, independently managing voltage levels in each zone, and adjusting power delivery to align with brightness or content requirements of pixels within that zone.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of scope, as the disclosure may admit to other equally effective embodiments.

FIG. 1 is a schematic of a panel or grid including multiple rows and columns forming multiple zones, according to embodiments.

FIG. 2 is an organic light-emitting diode (OLED) circuit, according to embodiments.

FIG. 3 is an I-V characteristic curve showing a dynamic V_{DD}-V_{SS}, according to embodiments.

FIG. 4A illustrates the power lines for the multiple V_{DD} zones, according to embodiments.

FIG. 4B illustrates the power lines for the multiple V_{SS} zones, according to embodiments.

FIG. 4C illustrates mesh V_{DD} power lines, according to embodiments.

FIG. 4D illustrates mess V_{SS} power lines, according to embodiments.

FIG. 5A illustrates the power lines for the overhang for the multiple V_{SS} zones, according to embodiments.

FIG. 5B illustrates stripe V_{SS} power lines, according to embodiments.

FIG. 6 is a flowchart for employing dynamic multi-zone V_{DD}-V_{SS} voltage control, according to embodiments.

FIG. 7 is a flowchart for eliminating or reducing unnecessary buffer voltages by dynamically lowering V_{DD}-V_{SS} in low-demand zones, according to embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments described herein generally relate to a display. More specifically, embodiments described herein relate to sub-pixel circuits and methods of forming sub-pixel circuits that may be utilized in a display such as an organic light-emitting diode (OLED) display. In various embodiments, the sub-pixels employ advanced pixel structures to improve functionality of the display.

OLED displays have self-emissive pixels delivering exceptional color accuracy, contrast ratios, and viewing angles. However, these benefits come at the cost of relatively high power consumption, especially in scenarios involving bright or large displays. Managing the power efficiency of OLED panels is a challenge for developers aiming to maximize performance while minimizing energy usage and heat generation.

At the core of OLED operation lies the interplay between the supply voltage (V_{DD}) and reference voltage (V_{SS}), which together create the electrical potential needed for driving current through the organic layers of the display. This current governs the brightness of each pixel, scaling non-linearly with the pixel's luminance. Conventional OLED designs rely on fixed V_{DD} and V_{SS} values applied uniformly across the entire display. While this approach simplifies the circuit design and ensures consistent performance, it introduces inefficiencies in scenarios where pixel brightness varies significantly across the panel.

The primary issue with fixed V_{DD} and V_{SS} is the inability to adapt to the varying power needs of different regions of the display. For example, zones displaying black or dark content consume far less current than bright areas. Yet, a fixed high V_{DD} is applied uniformly, wasting power in regions that need minimal energy. This surplus voltage results in unnecessary energy dissipation, reduced battery life in portable devices, and excess heat generation that can degrade display performance over time.

Moreover, the overhang problem exacerbates pixel aging and burn-in, as constant high voltage accelerates the degradation of organic materials in pixels that are frequently active. In large OLED panels or those with high-resolution content, where different zones may simultaneously display varying brightness levels, this inefficiency becomes even more pronounced. Bright zones continue to consume the power they need, but darker zones still experience excessive voltage application, leading to a power waste that could otherwise be avoided.

To address these challenges, the examples present a dynamic multi-zone control of V_{DD} and V_{SS}. By dividing the OLED panel into zones and dynamically adjusting the supply and reference voltages based on real-time content, this approach reduces power overhang and optimizes energy usage. This approach not only enhances the efficiency of OLED displays but also extends their lifespan and improves thermal management. Dynamic voltage control involves the real-time adjustment of the V_{DD} and V_{SS} across the OLED panel. By tailoring the voltage levels to the instantaneous display content and regional brightness demands, the system minimizes unnecessary energy dissipation. As such, traditional OLED displays apply a uniform voltage across the entire panel, which is inefficient when certain regions need lower brightness or are completely inactive. In contrast, dynamic multi-zone control overcomes this limitation by dividing the display into distinct zones, each with independently adjustable voltage levels. Depending on the display content, adjustments can be made to lower the power consumption.

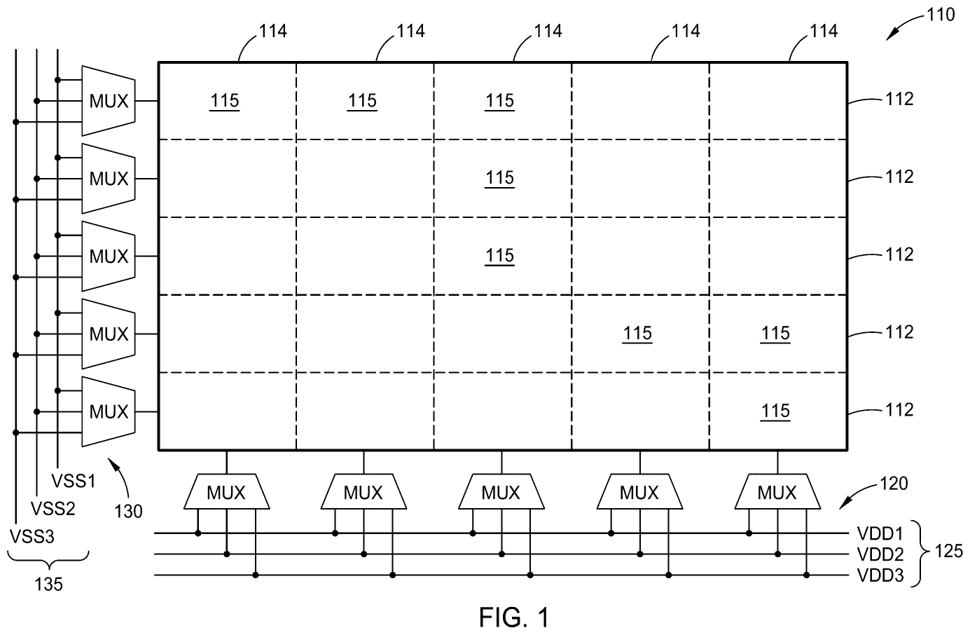

FIG. 1 is a schematic of a grid or panel including multiple rows and columns forming multiple zones, according to embodiments.

The display device or OLED display panel 110 includes multiple rows 112 and multiple columns 114 that form zones 115. The OLED display panel 110 has a grid-like pattern. In this non-limiting example, a 5×5 OLED display panel 110 is shown. The OLED display panel 110 may include more or less rows and columns. The number and size of the zones can be adjusted based on the application and resolution of the OLED panel. Multiple rows 112 are coupled to multiplexers 120 for controlling V_{DD} voltages 125. Multiple columns 114 are coupled to multiplexers 130 for controlling V_{SS} voltages 135. In other words, multiple rows 112 are coupled to the multiplexers 130 for controlling V_{SS} and multiple columns 114 are coupled to the multiplexers 120 for controlling V_{DD}. As such, for a 5×5 OLED display panel, the panel is divided into 5 horizontal rows and 5 vertical columns, forming a total of 25 zones (5×5=25). Each zone corresponds to a specific subset of pixels within the display, and these zones are defined physically or electronically through circuit design. Each zone 115 can have a different V_{DD}-V_{SS}.

The zones 115 are independently controlled regions of the OLED display panel 110. Each zone 115 represents a subset of pixels grouped together within the physical structure of the display. Zones optimize power efficiency and performance by tailoring the supply voltage (V_{DD}) and reference voltage (V_{SS}) to the specific content being displayed in that region. As such, the OLED display panel 110 is divided into multiple regions or “zones,” organized in a grid-like structure. Each zone 115 includes a distinct set of pixels and has separate circuitry for controlling V_{DD} and V_{SS}. Each zone 115 has its own dedicated power supply lines or regulators for V_{DD} and V_{SS}. This allows the voltage levels in each zone 115 to be dynamically adjusted based on the brightness or content requirements of the pixels within that zone.

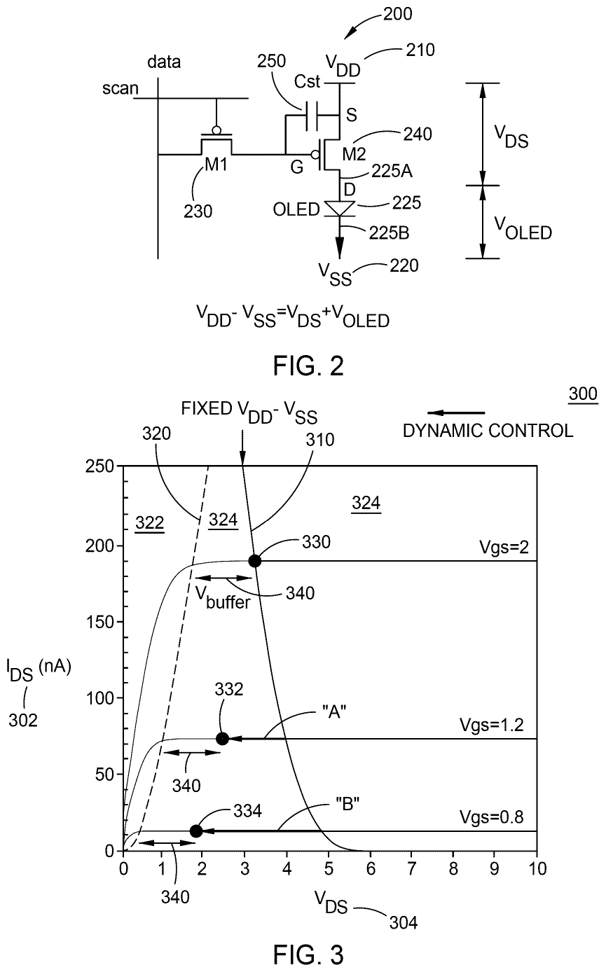

The content displayed in each zone 115 may be pre-analyzed (e.g., during a data refresh cycle), and the voltage levels for optimal performance are calculated. For example, a zone displaying a bright image may receive a higher V_{DD} to ensure sufficient luminance and a zone displaying dark content can operate with lower V_{DD} and potentially adjust V_{SS}, conserving power. A data refresh time is the time it takes for the display controller to send new data (e.g., brightness and color values) to all the pixels in the display grid or display device or panel. Data refresh time may be measured in milliseconds (ms). The data refresh time is linked to the refresh rate of the display, which is expressed in hertz (Hz). The row and column drivers in the OLED circuit of FIG. 2 below update pixel voltages row by row. During each refresh cycle, new image data is loaded into the OLED display device, and the pixel brightness levels are adjusted accordingly.

By dividing the panel into zones 115, the system can deliver the appropriate power to each area without wasting energy on parts of the display that do not need it. This reduces overall power consumption and minimizes heat generation. Smaller zones mean shorter power traces within each region, reducing resistance and associated IR drop (voltage drop due to resistance). This helps maintain consistent voltage levels across the display device, ensuring uniform brightness and image quality. In high-resolution displays or display devices, different parts of the screen often show content with varying brightness levels. Dynamic zone control allows for precise voltage adjustments in each area, enabling enhanced contrast and power savings. By limiting power delivery to zones that need it, the system reduces localized heating, preventing thermal hotspots that could degrade the OLED display's performance and longevity.

Dynamic multi-zone control for V_{DD} and V_{SS} introduces a high degree of precision and adaptability in power management for OLED displays. For example, if a system has 48 zones for V_{DD} and 30 zones for V_{SS}, the combination of these zones enables up to 1440 unique regions (48×30) across the display where V_{DD} and V_{SS} can be independently optimized. With 48 V_{DD} zones running horizontally and 30 V_{SS} zones running vertically, their intersection creates a total of 1440 independently controllable regions. This architecture allows fine-grained control of power delivery, tailored to the content displayed in each zone. The fine granularity of 1440 zones allow precise voltage management, significantly reducing overall power consumption. Zones displaying low-power content (e.g., black or static images) receive minimal power. High-luminance regions are given just enough power to maintain brightness, avoiding overdriving and reducing unnecessary energy use.

In traditional display devices, fixed V_{DD} and V_{SS} values often lead to brightness inconsistencies due to IR drop (voltage loss across resistive power lines). IR drop is a natural consequence of current flowing through resistive materials, such as the thin metallic traces used in OLED panel circuitry. With, e.g., 1440 zones, each region compensates for voltage losses locally, ensuring uniform brightness and color accuracy across the panel or display device. This is beneficial for large displays or high-resolution panels where voltage disparities can be more pronounced. Dynamic control of, e.g., 1440 zones significantly reduces localized heating. Zones with low power demands generate less heat, preventing thermal hotspots. Overall heat dissipation is minimized, extending the lifespan of the OLED panel and maintaining consistent performance over time. The 48×30 zoning structure is also scalable. For smaller displays, fewer zones may be implemented, simplifying the control circuitry. For larger panels, increasing the number of zones enables even finer control and improved performance. This flexibility makes the approach suitable for a wide range of applications. The 48×30 zoning structure is merely used as an illustrative example. Other zoning structure dimensions may also be used based on application.

Lower V_{DD} and V_{SS} levels reduce power consumption, leading to longer battery life in portable devices and lower operating costs for large displays. Reduced power dissipation minimizes heat generation, improving the overall reliability and lifespan of the OLED panel.

FIG. 2 is an organic light-emitting diode (OLED) circuit, according to embodiments.

The OLED circuit 200 includes V_{DD} 210 and V_{SS} 220. V_{DD} (supply voltage) is the relatively positive voltage supplied to the OLED panel's circuits. V_{DD} provides the necessary energy to drive the OLED pixels and power the supporting control electronics. V_{SS} (reference voltage) is the reference voltage to which the current from V_{DD} returns after passing through the circuit. Together, V_{DD} and V_{SS} establish the electrical potential difference needed to drive current through the organic layers of the OLED, enabling electron-hole recombination and light emission. The voltage difference between V_{DD} and V_{SS} determines the energy supplied to the OLED pixels. Higher voltages result in more current, leading to increased brightness. In one non-limiting example, the V_{DD} can be +5V and the V_{SS} can be −4V.

In one example, the anode 225A of the diode 225 may be a transparent electrode that injects holes (positive charge carriers) into the organic layers of the OLED device. In one example, the anode 225A may be made of indium tin oxide (ITO), which is conductive and transparent to allow light to pass through. In other examples, the anode 225A includes TCO/metal/TCO, which is a reflective layer stack, where TCO is a transparent conducting oxide layer. The cathode 225B of the diode 225 injects electrons (negative charge carriers) into the OLED stack. The cathode 225B is usually made from metals such as aluminum (Al) to facilitate electron injection into the organic layers. The OLED diode 225 includes several organic layers confined between the anode 225A and the cathode 225B. These layers are an emissive layer (EML), a hole transport layer (HTL), and an electron transport layer (ETL). When current flows through the OLED diode 225, electrons from the cathode 225A and holes from the anode 225B combine in the EML. This recombination releases energy in the form of light.

The OLED circuit 200 also includes a first transistor 230, a second transistor 240, and a capacitor 250. The voltage across the first transistor 230 is V_{DS}. This transistor may be responsible for current control, ensuring that a specific current flows through the OLED diode 225. The voltage across the OLED diode is V_{OLED}. The first transistor 230 works in conjunction with the second transistor 240 to provide the proper current for driving the OLED pixel. Thus, if the content is brighter, then the current is higher, and the V_{OLED} is also higher. If V_{OLED} is higher for higher brightness, then V_{DS} becomes smaller. As such, when V_{DD}-V_{SS} is fixed, the V_{DS} changes based on the content, that is the brightness of the content.

The second transistor 240 may be a thin film transistor (TFT) that controls the flow of current to the OLED diode 225. The second transistor 240 ensures that the correct amount of current is applied to the OLED for efficient light emission. The capacitor 250 is used to stabilize the voltage or smooth out fluctuations in the power supplied to the OLED diode 225. The capacitor 250 helps maintain a stable and consistent voltage across the OLED to ensure uniform brightness and reduce flicker in the OLED display. Thus, the two transistors control the flow of current in the OLED diode 225 and the capacitor 250 ensures that the voltage supplied to the OLED is stable. The combination of transistors regulates how much current flows to the OLED diode 225, controlling brightness of the individual pixel, and the capacitor 250 ensures there is no significant drop or variation in voltage.

FIG. 3 is an I-V characteristic curve showing a dynamic V_{DD}-V_{SS}, according to embodiments.

The graph 300 shows the I-V characteristic curve with a dynamic V_{DS}. The y-axis represents the drain current (I_{DS}) 302 and the x-axis represents the drain-source voltage (V_{DS}) 304. The graph 300 shows I_{DS} versus V_{DS} is to illustrate the behavior of a field-effect transistor (FET) in different operating regions. The line 320 shows the boundary between the linear region 322 and the saturation region 322. Lower V_{G} is at the bottom of the graph 300 and higher V_{G} is at the top of the graph 300. Higher V_{G} represents higher levels of brightness and lower V_{G} represents lower levels of brightness. The OLED display operates in the saturation region 324.

The V_{DD}-V_{SS} is represented by curved line 310. The V_{DD}-V_{SS} thus follows the curved line 310. For brighter content, V_{GS} is higher, which makes V_{DS} smaller, and V_{OLED} is higher. As such, the current is increased to accommodate the brighter content. The curved line 310 shows three operating points. A first operating point 330 for V_{GS}=2, a second operating point 332 for V_{GS}=1.2, and a third operating point 334 for V_{GS}=0.8. A buffer voltage (V_{buffer}) 340 is also shown between the curved line 310 and the line 320. The buffer voltage 340 is measured in the saturation region 324. The buffer voltage 340 is used to compensate for the IR drop.

When the content is darker, the V_{GS} voltage is too high. As such, the second operating point 332 and the third operating point 334 need to be moved closer to the line 320. This is shown by arrow A for the second operating point 332 and by arrow B for the third operating point 334. This helps maintain a constant or consistent buffer voltage 320 for every operating point. As such, it is desired to maintain the same buffer voltage 340 for each operating point, whether the content is brighter or darker. As such, the V_{DD}-V_{SS} is dynamically adjusted to move the second and third operating points to the left, to adjust the buffer voltage. Thus, a smaller voltage can used for darker content, which saves power or reduces power consumption.

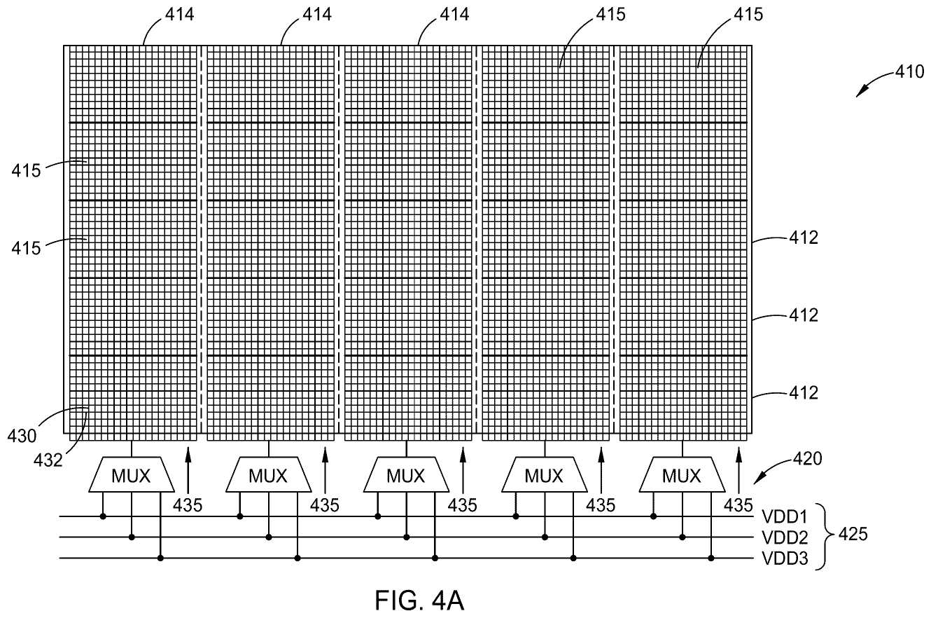

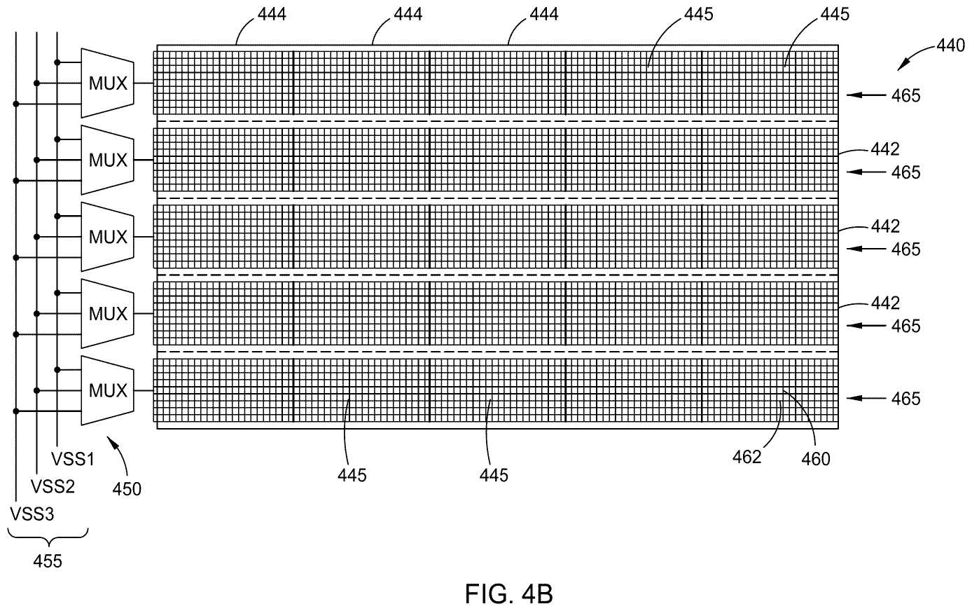

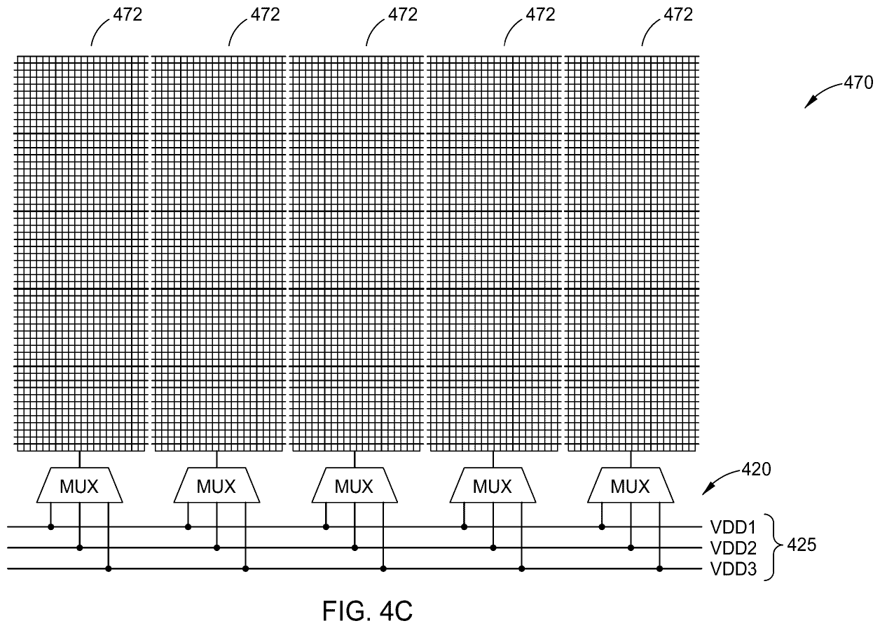

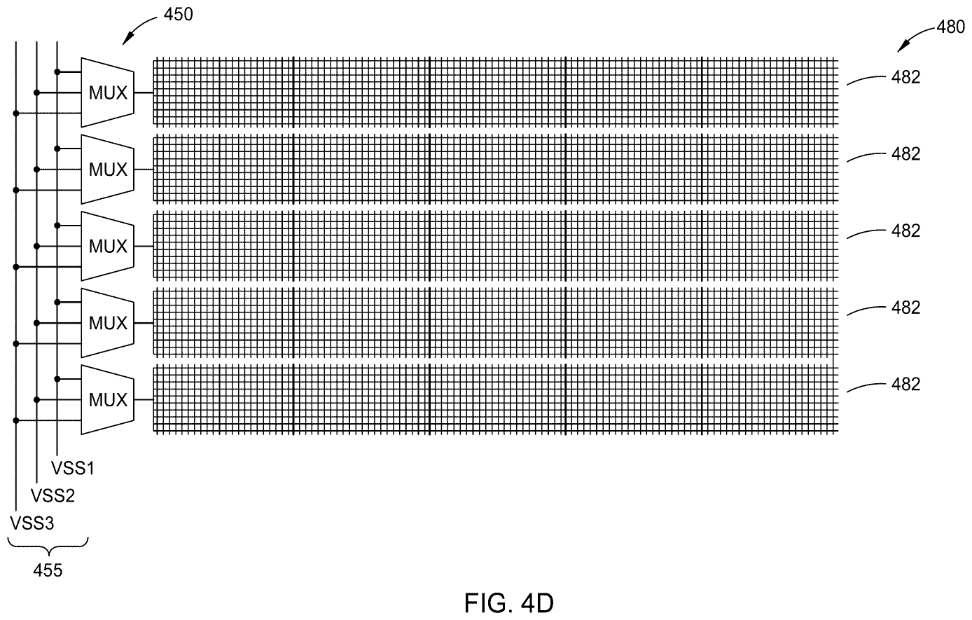

FIG. 4A illustrates the power lines for the multiple V_{DD} zones, according to embodiments.

The OLED panel 410 includes multiple rows 412 and multiple columns 414, and is partitioned into multiple zones 415, with each zone 415 dynamically managed based on its content. For instance, zones displaying dark or black content use minimal voltage, while brighter regions are allocated higher voltages. This granular control significantly reduces the overall power consumption. The zone-based approach leverages the fact that OLED power usage scales non-linearly with brightness, making targeted voltage adjustments particularly impactful for regions of low or moderate brightness.

Dynamic multi-zone control systems may employ drivers and controllers capable of monitoring display content in real-time. These controllers analyze the brightness levels for each zone and adjust the corresponding V_{DD} and V_{SS} voltages accordingly. Advanced algorithms ensure smooth transitions between zones to prevent visual artifacts, such as flickering or banding. Additionally, sensors and predictive models can be integrated to anticipate and pre-emptively adjust voltages, further enhancing system responsiveness and efficiency. In the example, each column 414 is coupled to a respective multiplexer 420, for simplicity, for controlling the V_{DD} voltages 425.

One aspect of this approach is the pre-analysis of display content during the data refresh cycle. As new image data is sent to the panel, it is analyzed in real time to determine the brightness and contrast requirements of each zone. Algorithms assess factors like pixel intensity, transitions between frames, and overall power demands. Based on this analysis, appropriate V_{DD} and V_{SS} levels are calculated and set for each zone just before the data is refreshed. For instance, if a zone is displaying a black or dark image, V_{DD} can be significantly lowered, and V_{SS} adjusted accordingly to minimize power consumption. Conversely, for zones displaying bright content, higher voltages are applied to maintain luminance and color fidelity. This dynamic adjustment ensures optimal energy usage without compromising visual quality.

Additionally, power lines are distributed across the rows 412 and columns 414 of the OLED panel 410. For example, horizontal power lines 430 extend along the rows 412 and vertical power lines 432 extend along the columns 414. The horizontal power lines 430 and the vertical power lines 432 collectively form mesh power lines 435. Each mesh power line 435 extends vertically along each column. Thus, 5 mesh power lines 435 are defined. The horizontal lines are not connected. Stated differently, there are 5 vertical power line zones that run vertically along the entire OLED panel. The 5 vertical power line zones do not form a single matrix. Each of the 5 vertical power line zones is independently controlled by its own multiplexer. Vertical mesh power lines run parallel to the height of the OLED display, connecting power sources to specific regions of the OLED panel. Unlike a grid, these lines are independently controlled meaning that they do not cross-connect horizontally to form a complete matrix. Each vertical mesh is thus individually managed allowing for selective power delivery or dynamic adjustments to specific regions of the OLED display.

The mesh power lines 435 may be used to distribute power uniformly, to minimize voltage drop, and/or to support large panels. Mesh power line designs thus ensure current delivery across the OLED panel to maintain uniform brightness and to avoid hotspots or dim areas. The mesh power line designs may also reduce resistive losses along the power delivery network to maintain stable voltage levels across the entire OLED panel.

The power lines 430 and the power lines 432 ensure that every pixel or subpixel receives the voltage and current needed to operate. The purpose of the power lines 430 and the power lines 432 in the OLED panel 410 is to deliver the electrical supply for the OLED diodes in each pixel. Each OLED diode needs a specific voltage and current to emit light, and this is achieved by controlling the voltage applied to the anode and cathode of the OLED diode, as shown in the OLED circuit of FIG. 2. The power lines 430 and the power lines 432 help maintain the uniformity of brightness, color accuracy, and overall image quality by supplying the appropriate levels across the entire OLED display. With the power lines 430 and the power lines 432 spanning across both the rows and the columns, voltage drops are minimized, and power is delivered efficiently to every pixel. Also, extending the power lines 430 and the power lines 432 across all rows and columns ensures that the current is distributed evenly, preventing localized overheating or power surges that may damage the OLED display.

FIG. 4B illustrates the power lines for the multiple V_{SS} zones, according to embodiments.

The OLED panel 440 includes multiple rows 442 and multiple columns 444, and is partitioned into multiple zones 445, with each zone 445 dynamically managed based on its content. For instance, zones displaying dark or black content use minimal voltage, while brighter regions are allocated higher voltages. This granular control significantly reduces the overall power consumption. The zone-based approach leverages the fact that OLED power usage scales non-linearly with brightness, making targeted voltage adjustments particularly impactful for regions of low or moderate brightness. In the example, each column 444 is coupled to a respective multiplexer 450, for simplicity, for controlling the V_{SS} voltages 455.

Additionally, power lines are distributed across the rows 442 and columns 444 of the OLED panel 440. For example, horizontal power lines 460 extend along the rows 442 and vertical power lines 462 extend along the columns 444. The horizontal power lines 460 and the vertical power lines 462 collectively form mesh power lines 465. Each mesh power line 465 extends horizontally along each row. Thus, 5 mesh power lines 465 are defined. The vertical lines are not connected. Stated differently, there are 5 horizontal power line zones that run horizontally along the entire OLED panel. The 5 horizontal power line zones do not form a single matrix. Each of the 5 horizontal power line zones is independently controlled by its own multiplexer. Horizontal mesh power lines run parallel to the width of the OLED display, connecting power sources to specific regions of the OLED panel. Unlike a grid, these lines are independently controlled meaning that they do not cross-connect vertically to form a complete matrix. Each horizontal mesh is thus individually managed allowing for selective power delivery or dynamic adjustments to specific regions of the OLED display.

The mesh power lines 465 may be used to distribute power uniformly, to minimize voltage drop, and/or to support large panels. Mesh power line designs thus ensure current delivery across the OLED panel to maintain uniform brightness and to avoid hotspots or dim areas. The mesh power line designs may also reduce resistive losses along the power delivery network to maintain stable voltage levels across the entire OLED panel.

The power lines 460 and the power lines 462 ensure that every pixel or subpixel receives the voltage and current needed to operate. The purpose of the power lines 460 and the power lines 462 in the OLED panel 440 is to deliver the electrical supply for the OLED diodes in each pixel. Each OLED diode needs a specific voltage and current to emit light, and this is achieved by controlling the voltage applied to the anode and cathode of the OLED diode, as shown in the OLED circuit of FIG. 2. The power lines 460 and the power lines 462 help maintain the uniformity of brightness, color accuracy, and overall image quality by supplying the appropriate levels across the entire OLED display. With the power lines 460 and the power lines 462 spanning across both the rows and the columns, voltage drops are minimized, and power is delivered efficiently to every pixel. Also, extending the power lines 460 and the power lines 462 across all rows and columns ensures that the current is distributed evenly, preventing localized overheating or power surges that may damage the OLED display.

FIG. 4C illustrates mesh V_{DD} power lines, according to embodiments.

Graph 470 shows the vertical meshes 472 for the V_{DD} power lines. Thus, only vertical meshes are connected to separate V_{DD} lines arranged in columns. The columns do not connect. Since each column has its own V_{DD} line, the IR drop is contained within individual columns, reducing cross column power fluctuations.

FIG. 4D illustrates mess V_{SS} power lines, according to embodiments.

Graph 480 shows the horizontal meshes 482 for the V_{SS} power lines. Thus, only horizontal meshes are connected to separate V_{SS} lines arranged in rows. The rows do not connect. Since each row has its own V_{SS} line, the IR drop is contained within individual rows, reducing cross row power fluctuations.

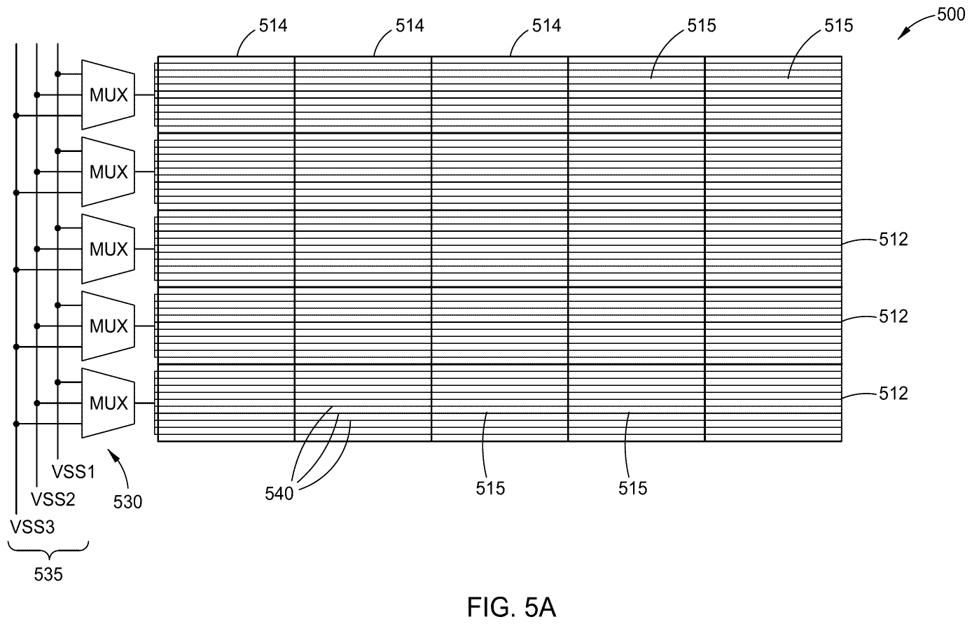

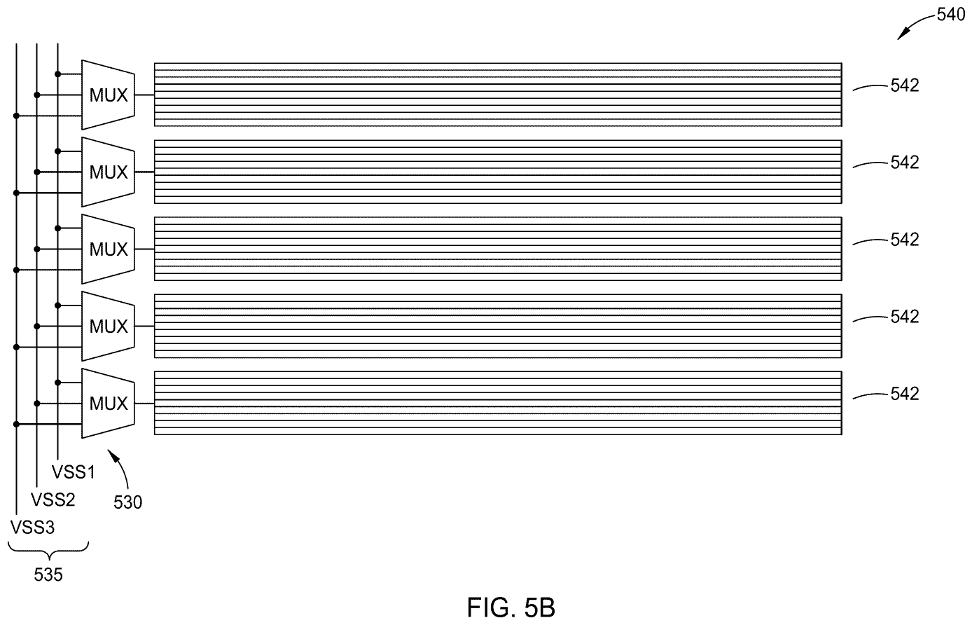

FIG. 5A illustrates the power lines for the overhang for the multiple V_{SS} zones, according to embodiments.

The OLED panel 500 includes multiple rows 512 and multiple columns 514, and is partitioned into multiple zones 515, with each zone 515 dynamically managed based on its content. For instance, zones displaying dark or black content use minimal voltage, while brighter regions are allocated higher voltages. This granular control significantly reduces the overall power consumption. The zone-based approach leverages the fact that OLED power usage scales non-linearly with brightness, making targeted voltage adjustments particularly impactful for regions of low or moderate brightness. In the example, each row 512 is coupled to a respective multiplexer 530, for simplicity, for controlling the V_{SS} voltages 535. The OLED panel 500 includes horizontal power lines 540 extending across the rows 512. The OLED panel 500 may be referred to as a stripe V_{SS} power line in a grid-wide connection that runs across the OLED display in a striped pattern. These stripes (or horizontal power lines 540) are integrated into the display layout to provide the potential for each pixel of group of pixels. The stripes do not include any vertical power lines.

The horizontal power lines 540 serve to distribute electrical power across the OLED panel, ensuring consistent voltage and current delivery to the active layers of the OLED display. The horizontal power lines 540 may be stripes formed as thin conductive lines made of low-resistance materials like silver, copper, or graphene, that run across the width of the OLED panel. The horizontal power lines 540 deliver current evenly across the width of the OLED display to ensure all pixels in a given row receive a stable voltage. The horizontal power lines 540 acts as low-resistance pathways that reduce voltage drops and improve the electrical performance of the OLED display.

Benefits of individual V_{DD} and V_{SS} control and dynamic multi-zone control include lowering V_{DD} in darker zones, which significantly reduces overall energy consumption, operating OLED pixels at lower voltages where possible decreases heat output, improving device reliability and user comfort, and minimizing stress on OLED materials, which reduces pixel degradation and delays burn-in effects. Adaptive control thus ensures that bright and high-contrast zones are adequately powered, maintaining image quality.

FIG. 5B illustrates stripe V_{SS} power lines, according to embodiments.

Graph 540 shows the horizontal stripes 542 for the V_{SS} power lines. Thus, only horizontal stripes are connected to separate V_{SS} lines arranged in rows. The rows do not connect. Since each row has its own V_{SS} line, the IR drop is contained within individual rows, reducing cross row power fluctuations.

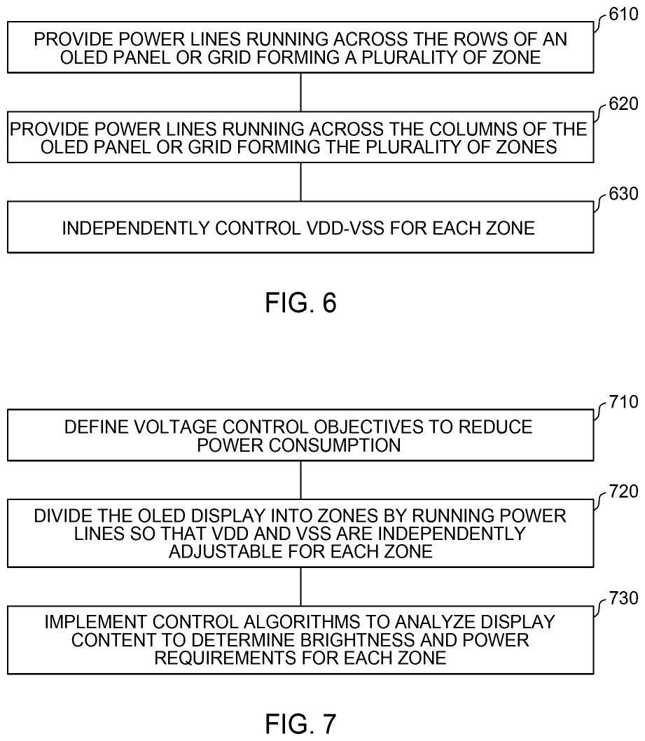

FIG. 6 is a flowchart for employing dynamic multi-zone V_{DD}-V_{SS} voltage control, according to embodiments.

At 610, power lines running across the rows of an OLED panel or grid forming a plurality of zones are provided. The power lines may form horizontal meshes. The horizontal meshes do not form a single matrix.

At 620, power lines running across the columns of the OLED panel or grid forming the plurality of zones are provided. The power lines may form vertical meshes. The vertical meshes do not form a single matrix.

At 630, V_{DD} and V_{SS} are independently controlled for each zone. Independent control of V_{DD}-V_{SS} in OLED displays allows for precise power management tailored to the specific needs of each zone or pixel group. Each zone can dynamically adjust its voltage levels based on real-time content analysis, ensuring that only the required power is delivered to active regions while minimizing energy waste in inactive or low-demand areas.

FIG. 7 is a flowchart for eliminating or reducing unnecessary buffer voltages by dynamically lowering V_{DD}-V_{SS} in low-demand zones, according to embodiments.

At 710, voltage control objectives are defined to reduce power consumption. The goal is to reduce power consumption by supplying only the required voltage to each zone or pixel group. V_{DD} and V_{SS} can be optimized based on display content.

At 720, the OLED display is divided into zones by running power lines so that V_{DD} and V_{SS} are independently adjustable for each zone. The zones are aligned with pixel arrangements for efficient control. The power lines are constructed so that V_{DD} and V_{SS} are independently adjustable for each zone.

At 730, control algorithms are implemented to analyze display content to determine brightness and power requirements for each zone. The control algorithms analyze the display content to determine brightness and power requirements for each zone. For example, V_{DD}-V_{SS} levels are reduced for darker zones or idle areas.

Therefore, implementing multiple zones for V_{DD} and V_{SS} in OLED displays introduces a new level of control and efficiency. By dividing the OLED panel into zones and independently managing the voltages in each zone, the system optimizes power delivery to align with specific content requirements. This approach addresses inefficiencies in traditional fixed-voltage designs and enhances the performance and lifespan of the display.

The ability to control V_{DD} and V_{SS} independently in each zone allows for tailored voltage delivery based on the content displayed in that zone. For instance, zones displaying darker content need less current and can operate at lower V_{DD}. Similarly, zones with minimal brightness demands can have their V_{SS} slightly adjusted to maintain the necessary voltage difference without wasting power. This precise adjustment reduces overall power consumption and heat generation.

In traditional designs, IR drop across the power delivery network can cause brightness inconsistencies due to uneven V_{DD} or V_{SS} levels. With multiple zones each zone compensates for its specific voltage needs, eliminating the effects of IR drop. The result is uniform brightness and color accuracy across the entire display, which is beneficial for high-resolution or large OLED panels.

Power loss in OLED panels often manifests as heat, which can degrade display performance and efficiency over time. Multi-zone V_{DD} and V_{SS} control localizes voltage adjustments, reducing unnecessary energy dissipation and ensures cooler operation, enhancing the thermal reliability of the display and surrounding components.

OLED panels often display content with varying brightness levels. Multiple V_{DD} and V_{SS} zones allow bright zones to operate at higher V_{DD} and V_{SS} levels for maximum luminance and contrast and dark zones to conserve energy by reducing voltages. This adaptability ensures that both bright and dark areas are optimized simultaneously without compromising image quality.

Moreover, in conventional OLED displays with fixed V_{DD} and V_{SS}, a buffer voltage is used to maintain a certain level of headroom to handle variations in voltage drop or current requirements. However, the buffer voltage may be unnecessary, especially in regions where the pixels are not demanding high brightness or power. By using dynamic V_{DD} and V_{SS} control, the buffer voltage can be eliminated or reduced in regions where power requirements are low, reducing overall power consumption. For example, in a static display with dark content, the buffer voltage that was previously used to compensate for power fluctuations can be entirely removed. This results in a direct reduction in the voltage supply, which in turn decreases the current flowing through the OLED display, thus reducing power consumption. As such, by dynamically adjusting the voltage, the overhead caused by the buffer voltage is minimized.

In summary, employing dynamic multi-zone V_{DD} and V_{SS} voltage control for OLED displays enables significant power savings and improved energy efficiency. In this approach, the V_{DD} (anode supply voltage) and V_{SS} (cathode reference voltage) are independently controlled in each zone of the display panel, allowing tailored power delivery based on the content being displayed. This dynamic control helps optimize the power consumption in real-time by adjusting voltages to match the varying demands of the display, such as reducing power in dark or idle regions and increasing it in bright, active areas. By dividing the panel into multiple zones for both V_{DD} and V_{SS}, each with its own voltage control, OLED displays can operate with enhanced precision. For example, if the display has 48 zones for V_{DD} and 30 for V_{SS}, the resulting configuration creates 1440 unique regions where voltage optimization occurs. This enables the system to efficiently manage the power delivered to the panel, reducing overall energy use while maintaining high image quality and performance across varying content. As such, depending on the display content, adjustments can be made to lower the power consumption.

A unique power line layout for both V_{DD} (anode) and V_{SS} (cathode) further enhances this dynamic control. For instance, V_{DD} and V_{SS} can have separate, distinct routing schemes that minimize losses and allow for better voltage regulation, especially for large panels. The voltage paths are designed to handle the specific current demands of the panel, reducing the occurrence of IR (voltage) drop, which is a common issue in traditional fixed voltage systems. This layout, combined with zone-based voltage control, prevents unnecessary power loss, contributing to the overall energy efficiency of the OLED system. In addition to power savings, this method helps in extending the lifespan of OLED displays by preventing over-driving in areas that do not need full power. By minimizing the thermal load and voltage stress on the individual pixels, the display operates more efficiently, generating less heat, and improving its durability over time. This method is useful in high-performance applications where battery life, thermal management, and power efficiency are critical.

While this specification contains many specific implementation details, these should not be construed as limitations on the scope of what may be claimed, but rather as descriptions of features that may be specific to particular implementations. Certain features that are described in this specification in the context of separate implementations may also be implemented, in combination, in a single implementation. Conversely, various features that are described in the context of a single implementation may also be implemented in multiple implementations, separately, or in any suitable sub-combination. Moreover, although previously described features may be described as acting in certain combinations and even initially claimed as such, one or more features from a claimed combination may, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional) to achieve desirable results. In certain circumstances, multitasking or parallel processing (or a combination of multitasking and parallel processing) may be advantageous and performed as deemed appropriate. While the various steps in an embodiment method or process are presented and described sequentially, one of ordinary skill in the art will appreciate that some or all of the steps may be executed in different order, may be combined, or omitted, and some or all of the steps may be executed in parallel. The steps may be performed actively or passively. The method or process may be repeated or expanded to support multiple components or multiple users within a field environment. Accordingly, the scope should not be considered limited to the specific arrangement of steps shown in a flowchart or diagram.

Furthermore, any claimed implementation is considered to be applicable to at least a computer-implemented method; a non-transitory, computer-readable medium storing computer-readable instructions to perform the computer-implemented method; and a computer system including a computer memory interoperability coupled with a hardware processor configured to perform the computer-implemented method or the instructions stored on the non-transitory, computer-readable medium.

Unless defined otherwise, all technical and scientific terms used have the same meaning as commonly understood by one of ordinary skill in the art to which these systems, apparatuses, methods, processes and compositions belong.

In this disclosure, the terms “top”, “bottom”, “side”, “above”, “below”, “up”, “down”, “upward”, “downward,” “horizontal,” “vertical,” and the like do not refer to absolute directions. Instead, these terms refer to directions relative to a nonspecific plane of reference. This non-specific plane of reference may be vertical, horizontal, or other angular orientation.

The singular forms “a”, “an”, and “the”, include plural referents, unless the context clearly dictates otherwise. Within a claim, reference to an element in the singular is not intended to mean “one and only one” unless specifically so stated, but rather “one or more”. Unless specifically stated otherwise, the term “some” refers to one or more.

Embodiments of the present disclosure may suitably “comprise”, “consist”, or “consist essentially of”, the limiting features disclosed, and may be practiced in the absence of a limiting feature not disclosed. As used here and in the appended claims, the words “comprise”, “has”, and “include”, and all grammatical variations thereof are each intended to have an open, non-limiting meaning that does not exclude additional elements or steps. “Optional” and “optionally” means that the subsequently described material, event, or circumstance may or may not be present or occur. The description includes instances where the material, event, or circumstance occurs and instances where it does not occur.

As used, the term “determining” encompasses a wide variety of actions. For example, “determining” may include calculating, computing, processing, deriving, investigating, looking up, for example, looking up in a table, a database, or another data structure, and ascertaining. In addition, “determining” may include receiving, for example, receiving information, and accessing, for example, accessing data in a memory. In addition, “determining” may include resolving, selecting, choosing, and establishing.

When the word “approximately” or “about” are used, this term may mean that there may be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

As used, terms such as “first” and “second” are arbitrarily assigned and are merely intended to differentiate between two or more components of a system, an apparatus, or a composition. It is to be understood that the words “first” and “second” serve no other purpose and are not part of the name or description of the component, nor do they necessarily define a relative location or position of the component. Furthermore, it is to be understood that that the mere use of the term “first” and “second” does not require that there be any “third” component, although that possibility is envisioned under the scope of the various embodiments described.

Although only a few example embodiments have been described in detail, those skilled in the art will readily appreciate that many modifications are possible in the example embodiments without materially departing from the disclosed scope as described. Accordingly, all such modifications are intended to be included within the scope of this disclosure as defined in the following claims. In the claims, means-plus-function clauses are intended to cover the structures described as performing the recited function and not only structural equivalents, but also equivalent structures. It is the express intention of the applicant not to invoke 35 U.S.C. § 112(f), for any limitations of any of the claims, except for those in which the claim expressly uses the words ‘means for’ together with an associated function.

While the foregoing is directed to embodiments of the present disclosure, other and further embodiments of the disclosure may be devised without departing from the basic scope thereof, and the scope thereof is determined by the claims that follow.

What is claimed is:

1. A display device, comprising:
a grid including rows and columns of organic light emitting diode (OLED) diodes, wherein zones are defined at intersections of the rows and columns;
first power lines extending across the rows; and
second power lines extending across the columns.

2. The display device of claim 1, wherein each row is connected to a respective first multiplexer.

3. The display device of claim 1, wherein each column is connected to a respective second multiplexer.

4. The display device of claim 1, wherein the first power lines are reference voltage (V_{SS}) power lines and the second power lines are supply voltage (V_{DD}) power lines or vice versa.

5. The display device of claim 4, wherein supply voltage (V_{DD}) and reference voltage (V_{SS}) are configured to be individually controlled in each column or row.

6. The display device of claim 4, wherein the V_{DD} and V_{SS} are configured to be dynamically adjusted based on a brightness or content requirements of pixels within that column or row.

7. The display device of claim 4, wherein content in each column or row is configured to be pre-analyzed to determine and set V_{DD} and V_{SS} during a data refresh time.

8. The display device of claim 4, wherein a pinch-off voltage changes over time as V_{DD} fluctuates, causing a point at which pinch-off occurs to vary dynamically.

9. A display device, comprising:
a grid divided into zones, each zone with independently adjustable voltage levels that are dynamically adjusted based on a brightness or content requirements of pixels within that zone;
reference voltage (V_{SS}) power lines extending across rows or columns of the grid; and
supply voltage (V_{DD}) power lines extending across columns or rows of the grid.

10. The display device of claim 9, wherein supply voltage (V_{DD}) and reference voltage (V_{SS}) are configured to be individually controlled in each column or row.

11. The display device of claim 9, wherein the V_{DD} and V_{SS} are configured to be dynamically adjusted based on the brightness or content requirements of the pixels within that column or row.

12. The display device of claim 9, wherein content in each column or row is configured to be pre-analyzed to determine and set V_{DD} and V_{SS} during a data refresh time.

13. The display device of claim 9, wherein a pinch-off voltage changes over time as V_{DD} fluctuates, causing a point at which pinch-off occurs to vary dynamically.

14. A method, comprising:
dividing a display into zones, the display forming a grid of rows and columns;
independently managing voltage levels in each zone; and
adjusting power delivery to align with brightness or content requirements of pixels within that zone.

15. The method of claim 14, wherein adjusting power delivery includes adjusting reference voltage (V_{SS}) power lines connected to rows or columns of the grid.

16. The method of claim 15, wherein adjusting the power delivery includes adjusting supply voltage (V_{DD}) power lines connected to columns or rows of the grid.

17. The method of claim 16, wherein supply voltage (V_{DD}) and reference voltage (V_{SS}) are configured to be individually controlled in each column or row.

18. The method of claim 17, wherein content in each column or row is configured to be pre-analyzed to determine and set V_{DD} and V_{SS} during a data refresh time.

19. The method of claim 17, wherein a pinch-off voltage changes over time as V_{DD} fluctuates, causing a point at which pinch-off occurs to vary dynamically.

20. The method of claim 17, wherein, when using dynamic V_{DD} and V_{SS} control, a buffer voltage is lowered in regions where power requirements are low to reduce power consumption.
